(19) United States
(12) Patent Application Publication
(10) Pub. No.: US 2006/0132034 A1
(43) Pub. Date: Jun. 22, 2006

(54) Organic light emitting device and method of manufacturing the same

(76) Inventors: Yoon-Hyeung Cho, Suwon-si (KR); Jong-Hyuk Lee, Suwon-si (KR); Won-Jong Kim, Suwon-si (KR); Min-Ho Oh, Suwon-si (KR); Jin-Baek Choi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/305,919

(22) Filed: Dec. 19, 2005

(30) Foreign Application Priority Data
Dec. 20, 2004 (KR) 10-2004-0108819

(51) Int. Cl. H05B 33/04; H05B 33/10

(52) U.S. Cl. 313/512; 313/509; 445/25

(57) ABSTRACT

An organic light emitting device with a transparent moisture absorption layer suitable for a front emission type and improved contrast and a method of manufacturing the organic light emitting device are provided. The organic light emitting device includes a substrate, an encapsulation substrate, an organic light emitting unit interposed between the substrate and the encapsulation substrate, and a transparent moisture absorption layer containing at least one of a metal oxide and a metal salt with an average particle diameter of 100 nm or less, a binder, and a light absorbing material absorbing light in a visible wavelength range.

### CROSS-REFERENCE TO RELATED APPLICATIONS

This application claims the benefit of Korean Patent Application No. 10-2004-0108819, filed on Dec. 20, 2004, in the Korean Intellectual Property Office, the disclosure of which is incorporated herein in its entirety by reference.

### BACKGROUND OF THE INVENTION

1. Field of the Invention

The present embodiments relate to an organic light emitting device and a method of manufacturing the same, and more particularly, to an organic light emitting device with improved contrast comprising a transparent moisture absorption layer suitable for a front emission type device, and a method of manufacturing the organic electroluminescent device.

2. Description of the Related Art

Organic electroluminescent devices are easily deteriorated by the permeation of moisture. Therefore, an encapsulation structure is required to ensure stability and an extended lifetime of an organic light emitting device.

Conventionally, a metal can or a glass substrate processed into a cap with a groove is used as an encapsulation device. According to this method, for moisture adsorption, a desiccant powder is mounted in the groove or a desiccant film is adhered to the groove by means of double-sided tape.

Japanese Laid-Open Patent Publication No. Hei 9-148066 discloses an organic electroluminescent device including a laminate having a pair of electrodes facing each other with an organic light-emitting material layer made of an organic compound interposed between the electrodes, an airtight container for preventing exposure of the laminate to air, and a drying compound, for example, alkali metal oxide, disposed in the airtight container. However, the bulky structure of the airtight container increases the total thickness of the organic electroluminescent device. Also, opaqueness of the drying compound renders the fabrication of a front emission type organic electroluminescent device difficult, even though the drying compound is maintained in a solid state after adsorbing moisture.

U.S. Pat. No. 6,226,890 describes an organic electroluminescent device including a moisture absorption layer produced using a desiccant and a binder, in which the desicant contains solid particles with a particle size of 0.1-200 μm

However, the organic electroluminescent device is translucent or opaque, and thus cannot be used as a front emission type device, and also has low moisture absorption ability.

In addition, the organic electroluminescent device includes a polarizing film having a transmittance of about 50% at an outer side of a sealing substrate thereof to improve the contrast and prevent a glass substrate from an external impact. However, the polarizing film is expensive and raises the unit manufacturing cost for the organic electroluminescent device. Therefore, there is a need for an alternative technology to overcome these disadvantages. The present embodiments do this and offer further advantages.

### SUMMARY OF THE INVENTION

The present embodiments provide an organic light emitting device with improved contrast comprising a transparent moisture absorption layer that has good moisture absorption properties and is suitable for a front emission type device, and a method of manufacturing the organic light emitting device.

According to an aspect of the present embodiments, there is provided an organic light emitting unit comprising: a substrate; an encapsulation substrate; an organic light emitting unit interposed between the substrate and the encapsulation substrate; and a transparent moisture absorption layer containing: at least one of a metal oxide and a metal salt with an average particle diameter of about 100 nm or less; a binder; and a light absorbing material absorbing light in a visible wavelength range.

According to another aspect of the present embodiments, there is provided a method of manufacturing an organic light emitting device, comprising: preparing a substrate with an organic light emitting unit including a first electrode, an organic layer, and a second electrode sequentially layered on the substrate; coating a composition for forming a transparent moisture absorption layer in an internal space between the substrate and the encapsulation substrate and curing the composition to obtain a transparent moisture absorption layer, the composition containing at least one of a metal oxide and a metal salt having an average particle diameter of about 100 nm or less, a binder, a light absorbing material capable of absorbing light in a visible wavelength range, and a solvent; coating a sealant on an outer region of the organic light emitting unit on at least one of the substrate and the encapsulation substrate; and combining the substrate and the encapsulation substrate.

### BRIEF DESCRIPTION OF THE DRAWINGS

The above and other features and advantages of the present embodiments will become more apparent by describing in detail exemplary embodiments thereof with reference to the attached drawings in which:

FIGS. 1A through 1D are schematic cross-sectional views of organic electroluminescent devices according to some embodiments;

FIGS. 2A and 2B illustrate structures of transparent moisture absorption layers formed in encapsulation substrates according to the present embodiments;

FIG. 3 illustrates the transmittance spectra of transparent moisture absorption layers formed according to Examples 1 through 3 and Comparative Example 1; and

FIG. 4 illustrates the lifetimes of organic light emitting devices according to Example 1 and Comparative Examples 1 and 2.

### DETAILED DESCRIPTION OF THE INVENTION

Certain embodiments will be described in detail below.

An organic light emitting device according to one embodiment includes a transparent moisture absorption layer which is suitable for a front emission type device. The transparent moisture absorption layer is obtained by coating and curing a composition containing at least one compound of a metal oxide and a metal salt having an average particle diameter of about 100 nm or less, a binder, a light absorbing material capable of selectively absorbing light in a visible wavelength range (in particular, from about 380 to about 780 nm), and a solvent. External light is less reduced, and about 50% of the external light is absorbed, so that the contrast is improved. When the transparent moisture absorption layer contains the light absorbing material, the transmittance of the transparent moisture absorption layer is controlled to be in a range of from about 40 to about 60%, for example, about 50%.

The light absorbing layer may comprise at least one material selected from the group consisting of an inorganic pigment, an inorganic dye, and a metal nanocolloid.

Examples of the inorganic pigment include titanium black, carbon black, cobalt aluminate, and any combination thereof. Examples of the inorganic dye include black dye, Levanyl Black, Nigrosin Black (Aldrich Co., Milwaukee, Wis.), Sudan Black, and a combination thereof. Examples of the metal nanocolloid include silver nanocolloid, gold nanocolloid, gold-silver nanocolloid, gold-ruthenium nanocolloid, and a combination thereof. A metal nano-colloid refers to a solution containing metal particles having an average particle diameter of about 5 to about 50 nm dispersed in a solvent, such as ethanol.

The amount of the light absorbing material may be in a range of about 0.1 to about 10 parts by weight based on 100 parts by weight of at least one of a metal oxide and a metal salt having an average particle diameter of 100 nm or less. If the amount of the light absorbing material is less than about 0.1 parts by weight, the transmittance increases to 90% or greater, so that an improvement in contrast is negligible. If the amount of the light absorbing material is larger than about 10 parts by weight, the transmittance decreases to 30% or less, thereby resulting in a great reduction in brightness.

The light absorbing material may have an average particle diameter of about 100 nm or less, for example, about 20 nm to about 80 nm. If the average particle diameter of the light absorbing material is greater than about 100 nm, light scattering occurs, resulting in haze.

The organic light emitting device according to the present embodiments may further include an anti-reflection layer on an external surface of an encapsulation substrate to prevent specular reflection. The anti-reflection layer is transparent, has a transmittance of about 90% or greater, for example, about 95% to about 98%, and can be manufactured at low cost. An example of the anti-reflection layer is a film with two layers, e.g., a high-refraction layer and a low-refraction layer, coated on a PET. The thickness of the anti-reflection layer is in a range of about 100 to about 125 μm.

In the transparent moisture absorption layer according to the present embodiments, the metal oxide reacts with water, breaking a metal-oxygen-metal bond to form a metal hydroxide, and thus, water is removed. When the transparent moisture absorption layer contains a metal salt, a water molecule is coordinated with the empty biding site of the center metal to form a stable compound, and thus, water is removed.

According to the present embodiments, the metal oxide or the metal salt is finely pulverized to an average particle diameter of about 100 nm or less using physical or chemical methods. Then, the metal oxide or metal salt particles are mixed with the binder and the light absorbing material, and the mixture is coated and cured.

The metal oxide or metal salt particles may have an average particle diameter of about 100 nm or less, for example, about 50 to about 90 nm. If the average particle diameter of the metal oxide or metal salt particles is greater than about 100 nm, scattering occurs in the visible light range in the moisture absorption layer obtained using the particles, resulting in haze (a phenomenon where the layer appears cloudy) and reducing the transmittance.

The binder used in the present embodiments may be an organic binder, an inorganic binder, an organic/inorganic complex binder, or a mixture thereof. The organic binder has a low molecular weight or a high molecular weight. The organic binder should be highly compatible with the metal oxide or metal salt particles and have an excellent ability to form a layer. The organic binder may include at least one compound selected from the group consisting of an acrylic resin, a methacrylic resin, polyisoprene, a vinyl resin, an epoxy resin, a urethane resin, and a cellulose resin. Examples of the acrylic resin include butyl acrylate, ethylhexyl acrylate, and the like. Examples of the methacrylic resin include propylene glycol methacrylate, tetrahydrofurfuryl methacrylate, and the like. Examples of the vinyl resin include vinyl acetate, N-vinylpyrrolidone, and the like. Examples of the epoxy resin include cycloaliphatic epoxide, and the like. Examples of the urethane resin include urethane acrylate, and the like. Examples of the cellulose resin include cellulose nitrate, and the like.

The inorganic binder is a metal or non-metal, such as silicon, aluminum, titanium, or zirconium. The inorganic binder should be highly compatible with the metal oxide or metal salt particles and have an excellent ability to form a layer. The inorganic binder may include at least one material selected from the group consisting of titania, silicon oxides, zirconia, alumina, and precursors thereof.

The organic/inorganic complex binder includes an organic material bound to a metal or non-metal, such as silicon, aluminum, titanium, or zirconium, via a covalent bond. The organic/inorganic complex binder should be highly compatible with the metal oxide or metal salt particles and be capable of forming a layer. The organic/inorganic complex binder may include at least one compound selected from the group consisting of epoxy silane or its derivatives, vinyl silane or its derivatives, amine silane or its derivatives, methacrylate silane or its derivatives, and a partially cured product thereof. The partially cured product is used to control a property of the composition, for example, viscosity.

Specific examples of the epoxy silane or its derivatives include 3-glycidoxypropyltrimethoxysilane and its polymer.

Specific examples of the vinyl silane or its derivatives include vinyltriethoxysilane and its polymer.

Specific examples of the amine silane or its derivatives include 3-aminopropyltriethoxysilane and its polymer.

Specific examples of the methacrylate silane or its derivative include 3-(trimethoxysilyl)propyl acrylate and its polymer.

The binder used in an embodiment may exhibit substantial thixotropy, which allows printing, and a leveling property.

The transparent moisture absorption layer according to the present embodiments may further contain a dispersant. A dispersant can increase dispersibility in a desiccant dispersion when the dispersion is mixed with the binder. Examples of a dispersant include a high molecular weight organic dispersant, a high molecular organic/inorganic complex dispersant, an organic acid, an inorganic acid, and the like. When such a dispersant is used, the diameter of the metal oxide particles, such as CaO, in the transparent moisture absorption layer may be, for example, between about 60 nm to 80 nm. If the dispersant is not used, the metal oxide particles are, for example, aggregated during the process, and thus, cannot exist between about 60 nm to 80 nm in the final transparent moisture absorption layer, even though the metal oxide particles are initially on the order of nm. To disperse the fine particles in the solution without aggregation and precipitation, two methods can be used. In the first method, surfaces of the particles are positively or negatively charged and, due to electrostatic repulsive forces between the charged particles, the aggregation of the particles can be prevented. In this method, the particles can be easily dispersed in the solution and if the particles are required to have electrical properties, the particles can be dispersed without changing the electrical properties of the particles. However, the electrical repulsive forces are weak and are greatly affected by the pH of the solution, and thus, the dispersibility can be easily lowered. In the second method, the particles are surrounded by high molecular weight dispersants, and due to steric hindrance between them, the particles are not aggregated. In this method, a wide range of solvents can be used regardless of their polarity and dispersion stability. However, particles having electrical properties cannot be used in this method and the used dispersant is expensive. The dispersant of the desiccant dispersion used in an embodiment has a high molecular weight, and thus, when the dispersant is mixed with the binder, the dispersibility can be maintained and the solution can be uniformly mixed.

The transparent moisture absorption layer can be formed in a thick layer using the above-mentioned binder and dispersant, and the amount of moisture absorbed can be increased by increasing the amount of nanosized desiccant impregnated in the layer. When a suitable kind of a binder is selected, a layer which is highly transparent at a thickness of about 100 μm or greater can be obtained. The viscosity of the composition for forming the transparent moisture absorption layer can be appropriately controlled using the binder, thereby enabling forming the transparent moisture absorption layer using a printing process.

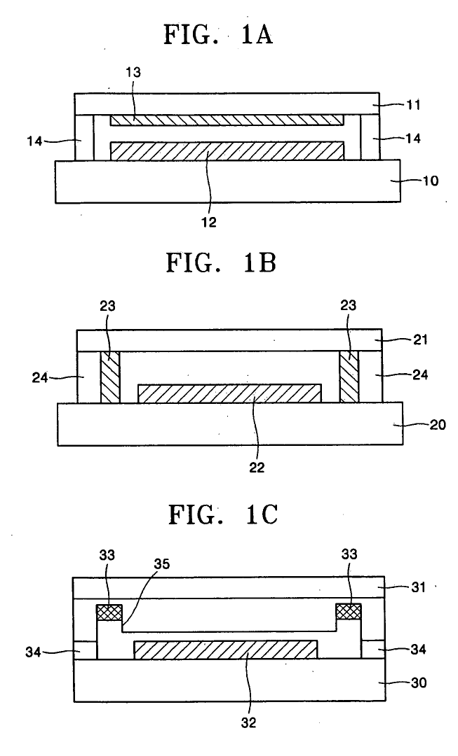

In the organic electroluminescent device according to the present embodiment, the transparent moisture absorption layer may be disposed in an internal space between a substrate and an encapsulation substrate. In particular, the transparent moisture absorption layer may be formed on an inner surface of the encapsulation substrate as illustrated in FIGS. 1A and 1D, on a sidewall of a sealant layer as illustrated in FIG. 1B, or on a portion of at least one of the substrate and the encapsulation substrate (for example, in a groove portion of the substrate as illustrated in FIG. 1C).

FIG. 1A is a schematic cross-sectional view of an organic light emitting device according an embodiment.

Referring to FIG. 1A, the organic light emitting device includes a substrate 10 formed of glass or a transparent insulating material, an organic light emitting unit 12 disposed on a surface of the substrate 10 and including a first electrode, an organic layer, and a second electrode sequentially layered, an encapsulation substrate 11 combined with the substrate 10 to seal an internal space between the substrate 10 and the encapsulation substrate 11, in which the organic light emitting unit 12 is contained, sealed from the outside, and a transparent moisture absorption layer 13 formed on an inner surface of the encapsulation substrate 11. The transparent moisture absorption layer 13 includes nanosized and porous oxide particles and nanosized pores.

The substrate 10 and the encapsulation substrate 11 are combined together by a sealant layer 14 coated on an outer portion of the organic light emitting unit 12. The encapsulation substrate 11 seals the organic light emitting unit 12 together with the substrate 10 and may have a shape as illustrated in FIG. 1B.

Referring to FIG. 1B, an organic light emitting device to according to another embodiment includes a substrate 20 formed of glass or a transparent insulating material, an organic light emitting unit 22 disposed on a surface of the substrate 20 and composed of a first electrode, an organic layer, and a second electrode sequentially layered, an encapsulation substrate 21 combined with the substrate 20 such that the internal space provided by the substrate 20 and the encapsulation substrate 21, in which the organic light emitting unit 22 is contained, is sealed from the outside, a transparent nano-porous oxide moisture absorption layer 23 disposed on sidewalls of a sealant layer 24.

Referring to FIG. 1C, an organic light emitting device according to another embodiment includes a substrate 30, an organic light emitting unit 32, an encapsulation substrate 31 defining an internal space when combined with the substrate 30 and having a groove portion 35 on its surface, a sealant layer 34, and a transparent moisture absorption layer 33 disposed in the groove portion 35.

Referring to FIG. 1D, an organic light emitting device according to another embodiment includes a substrate 40, an encapsulation substrate 41, which is an etched glass substrate, an organic light emitting unit 42, a sealant layer 44, a transparent moisture absorption layer 43 disposed in an etched portion of the etched glass substrate, and an anti-reflection layer 45 on an external surface of the encapsulation substrate 41. Although not illustrated in FIGS. 1A through 1C, the anti-reflection layer 45 may be formed on an external surface of each of the encapsulation substrates 11, 21, and 31 as in the organic light emitting device of FIG. 1D.

An etching depth (h) of the etched glass substrate may be about 100 to about 300 μm, but is not limited thereto. The transparent moisture absorption layer 43 may have a thickness of about 0.1 to about 300 μm but is not limited thereto.

The anti-reflection layer 45 may have a thickness of about 100 to about 125 μm.

In some embodiments, the transparent moisture absorption layers 13, 23, 33, and 43 may be thick transparent nano CaO layers.

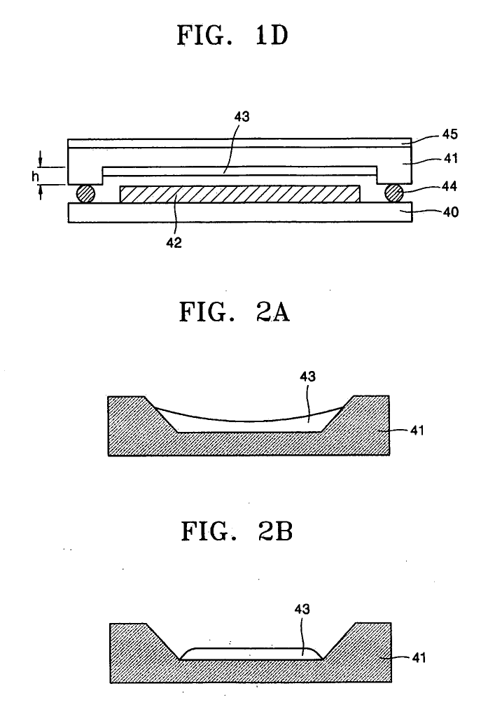

FIGS. 2A and 2B illustrate the structures of transparent moisture absorption layers 43 that can be formed on the encapsulation substrate 41, which is an etched glass substrate 41, of the organic light emitting device of FIG. 1D.

The organic light emitting units 12, 22, 32, and 42 may be formed by deposition and are each composed of a first electrode, an organic layer, and a second electrode which are sequentially deposited. The first electrode may be a cathode electrode, and the second electrode may be an anode electrode. The organic layer may include a hole injection layer, a hole transport layer, a light emitting layer, an electron injection layer, and/or an electron transport layer.

The encapsulation substrates 11, 21, 31, and 41 may be composed of an insulating material, for example, glass or a transparent plastic. A protective layer for preventing moisture permeation can be formed on an inner surface of the plastic substrate. The protective layer may be resistant to heat, chemicals, and humidity. When the encapsulation substrates 11, 21, 31, and 41 are composed of a transparent material, they can be used in front emission type devices.

To be used in a rear emission type device, the first electrode of each of the organic light emitting units 12, 22, 32, and 42 may be a transparent electrode, and the second electrode of each of the organic light emitting units 12, 22, 32, and 42 may be a reflective electrode. On the other hand, to be used in a front emission type device, the first electrode of each of the organic light emitting units 12, 22, 32, and 42 may be a reflective electrode, and the second electrode of each of the organic light emitting units 12, 22, 32, and 42 may be a transparent electrode. The first electrodes are respectively installed near the encapsulation substrates 11, 21, 31, and 41, and the second electrodes are respectively installed near the substrates 10, 20, 30, and 40.

A protective layer may be further formed on an upper surface of the second electrode to planarize the organic light emitting units 12, 22, 32, and 42 and provide resistance to heat, chemicals, and humidity. The protective layer may be composed of an inorganic material such as metal oxide or metal nitride.

The inner spaces defined by the encapsulation substrates 11, 21, 31, and 41 and the substrates 10, 20, 30, and 40 are maintained in a vacuum condition or filled with an inert gas.

The transparent moisture absorption layers 13, 23, 33, and 43 may be as thick as possible, as long as sufficient transmittance is obtained. For example, the transparent moisture absorption layers 13, 23, 33, and 43 may have a thickness of about 0.1 to about 300 μm. If the thickness is less than about 0.1 μm, the moisture absorption is decreased. If the thickness is greater than about 300 μm, which is larger than the sizes of beads in a sealant, the transparent moisture absorption layers 13, 23, 33, and 43 contact the cathode electrode and an area where moisture can permeate is increased.

When the encapsulation substrates 11, 21, 31, and 41 are formed of etched glass substrates as illustrated in FIG. 1D, the transparent moisture absorption layers 13, 23, 33, and 43 may have a thickness of about 0.1 to 300 μm. If the thicknesses of the transparent moisture absorption layers 13, 23, 33, and 43 are less than about 0.1 μm, the moisture absorption is decreased. If the thicknesses of the transparent moisture absorption layers 13, 23, 33, and 43 are greater than about 300 μm, which are greater than the etching depth (h) of the etched glass substrate, and thus, the transparent moisture absorption layers 13, 23, 33, and 43 contact the cathode electrode.

When the encapsulation substrates 11, 21, 31, and 41 are flat glass substrates, the transparent moisture absorption layers 13, 23, and 33 may have a thickness of about 0.1 to about 70 μm.

The transparent moisture absorption layers 13, 23, 33, and 43 may be composed of at least one compound selected from among an oxide of an alkali metal, such as lithium or sodium, an oxide of an alkali earth metal, such as calcium or barium, a metal halide, a metal sulfate, a metal perclorate, and a phosphorous pentoxide (P₂O₅), all of which have an average particle diameter of about 100 nm or less, and in particular, about 20 to about 100 nm.

The alkali metal oxide may be lithium oxide (Li₂O), sodium oxide (Na₂O), or potassium oxide (K₂O). The alkali earth metal oxide may be barium oxide (BaO), calcium oxide (CaO), or magnesium oxide (MgO). The metal sulfate may be lithium sulfate (Li₂SO₄), sodium sulfate (Na₂SO₄), calcium sulfate (CaSO₄), magnesium sulfate (MgSO₄), cobalt sulfate (CoSO₄), gallium sulfate (Ga₂(SO₄)₃), titanium sulfate (Ti(SO₄)₂), or nickel sulfate (NiSO₄). The metal halide may be calcium chloride (CaCl₂), magnesium chloride (MgCl₂), strontium chloride (SrCl₂), yttrium chloride (YCl₂), copper chloride (CuCl₂), cesium fluoride (CsF), tantalum fluoride (TaF₅), niobium fluoride (NbF₅), lithium bromide (LiBr), calcium bromide (CaBr₃), cerium bromide (CeBr₄), selenium bromide (SeBr₂), vanadium bromide (VBr₂), magnesium bromide (MgBr₂), barium iodide (BaI₂), or magnesium iodide (MgI₂). The metal perchlorate may be barium perchlorate (Ba(ClO₄)₂) or magnesium perchlorate (Mg(ClO₄)₂).

A method of manufacturing an organic light emitting device with such a transparent moisture absorption layer as described above according to an embodiment will be described in detail.

First, a substrate with an organic light emitting unit including a first electrode, an organic layer, and a second electrode, which are sequentially layered, is formed on a substrate. Then, at least one of a metal oxide and a metal salt in particle form is mixed with a solvent, a light absorbing material, and a binder to obtain a composition for forming a transparent moisture absorption layer. This composition may further contain a dispersant.

The composition for forming the transparent moisture absorption layer may be prepared according to the following process.

First, at least one of the metal oxide and the metal salt, which are desiccants, and the light absorbing material are mixed with the solvent. A dispersant can be further added into the mixture if required. The mixture is physically milled to obtain a dispersion containing a nano-sized desiccant. Then, the dispersion is mixed with the binder to prepare the composition for forming the transparent moisture absorption layer.

The solid concentration in the composition for forming the transparent moisture absorption layer is in a range of about 2 to about 25% by weight based on the total weight of the composition. If the solid concentration in the composition is less than about 2% by weight, the moisture absorption ability of the transparent moisture absorption layer is low. If the solid concentration in the composition is greater than about 25% by weight, the transmittance decreases and the haze increases, so that the resulting moisture absorption layer is opaque or semi-transparent.

After preparing the composition for forming the transparent moisture absorption layer, the composition is coated on an inner surface of an encapsulation substrate, dried, and then cured to obtain the transparent moisture absorption layer.

The coating may be performed using dip coating, spin coating, spray coating, dispensing, or screen printing. However, screen printing is preferred in view of workability.

When the transparent moisture absorption layer is formed using screen printing, the binder and the solvent in the composition function as vehicles for maintaining flowability of the composition to be printed. The composition for printing may have a viscosity of about 500 to about 20,000 cps. If the viscosity of the composition is not in the mentioned range, the workability of printing is decreased.

The curing may be performed using thermal curing or UV curing. The thermal curing may be performed at about 100 to about 250° C. If the temperature of the thermal curing is greater than about 250° C., the specific surface area of the particles is decreased due to pre-sintering of the particles, thereby decreasing the moisture absorption, and the binder is decomposed by heat. If the temperature of the thermal curing is less than about 100° C., the solvent remains in the transparent moisture absorption layer or the transparent moisture absorption layer is not cured, and thus, the device can be damaged after encapsulation.

The amount of the binder in the composition is in a range of about 10 to about 5000 parts by weight based on 100 parts by weight of at least one of the metal oxide and the metal salt. If the amount of the binder is less than about 10 parts by weight, a transparent moisture absorption layer cannot be easily obtained. If the amount of the binder is greater than about 5000 parts by weight, the moisture absorption ability is decreased.

The amount of the dispersant in the composition is in a range of about 1 to about 100 parts by weight based on 100 parts by weight of the at least one of the metal oxide and the metal salt. If the amount of the dispersant is less than about 1 part by weight, a transparent moisture absorption layer cannot be easily obtained. If the amount of the dispersant is greater than about 100 parts by weight, the moisture absorption ability is decreased.

The solvent may be any solvent that can disperse the metal oxide or metal salt particles therein. Specific examples of the solvent include ethanol, methanol, propanol, butanol, isopropanol, methyl ethyl ketone, propylene glycol, 1-monomethyl ether (PGM), isopropyl cellulose (IPC), methyl cellosolve™ (2-ethoxyethanol) (Dow Chemical, Midland, Mich.) (MC), and ethyl cellosolve™ (EC). The amount of the solvent is about 100 to about 1900 parts by weight based on 100 parts by weight of the at least one of the metal oxide and the metal salt.

The transparent moisture absorption layer formed according to the method described above is a thin or thick layer having a thickness of about 0.1 to about 300 μm and good moisture absorption and oxygen adsorption properties.

The transparent moisture absorption layer according to the present embodiments has a transmittance of about 95 to about 98% and a moisture absorption ratio of about 30 to about 50%.

When the transparent moisture absorption layer has a thick layer having a thickness of about 100 to about 300 μm, it has a transmittance of about 95% or greater, typically about 96 to about 98%, a moisture absorption ratio of about 30 to about 40%, and a haze of about 1.0 or less, typically about 0.2 to about 0.8.

After preparing the encapsulation substrate having the transparent moisture absorption layer thereon, a sealant is coated on at least one of the substrate and the encapsulation substrate in an outer portion of the organic light emitting unit using a screen printer or a dispenser. Then, the substrate is combined with the encapsulation substrate to obtain an organic light emitting device according to the present embodiments.

When an anti-reflective layer is formed on an external surface of the encapsulation substrate, after the substrate and the encapsulation substrate are combined, the anti-reflective layer is formed on the encapsulation layer using a laminating technique.

Further, an internal space of the organic light emitting device manufactured through the above-described processes may be vacuumed or filled with an inert gas, and after the substrate and the encapsulation substrate are combined, the sealant may be cured using, for example, UV light, visible light, or heat.

The transparent moisture absorption layer formed using the method can be transparent before and after it absorbs moisture.

The organic light emitting according to the present embodiments can be a front emission type, a rear emission type, or a dual emission type.

There are no particular limitations on a driving method for the organic light emitting device according to the present embodiments; both passive matrix (PM) driving and active matrix (AM) driving can be used.

According to the present embodiments, the transmittance of the transparent moisture absorption layer can be controlled to be in a range of about 40 to about 60% by appropriately controlling the amount of the light absorbing material in the transparent moisture absorption layer. In addition, the transparent moisture absorption layer can be substantially smooth and does not cause distortion in a displayed image, and thus can be used in a front transmission display. Therefore, a polarizing film having a transmittance of about 50%, which is attached to an external surface of the encapsulation layer to improve the contrast and protect the glass substrate from an external impact, can be replaced with an anti-reflective film having a transmittance of about 90%.

Hereinafter, the present embodiments will be described in more detail with reference to the following examples. However, these examples are given for the purpose of illustration and are not intended to limit the scope of the embodiments.

### EXAMPLE 1

100 parts by weight of anhydrous calcium oxide (CaO) (average particle diameter of 70 nm), 10 parts by weight of an organic/inorganic complex siloxane, epoxycyclohexyltrimethoxysilane, as a dispersant, and 5 parts by weight of titanium black (TiO) were mixed with 400 parts by weight of anhydrous ethanol and milled for 24 hours to obtain a dispersion having particles with an average particle diameter of 70 nm. The obtained dispersion was mixed with 3000 parts by weight of an organic binder, urethane acrylate, to prepare a composition for forming a transparent moisture absorption layer. The titanium black dispersed in the composition had an average particle diameter of 0.1 μm or less.

The composition was printed on an inner surface of an etched soda glass substrate and then thermally treated at 100° C. and UV-cured to form a transparent moisture absorption layer.

An epoxy resin was coated as a sealant on at least a portion of the soda glass substrate with the transparent moisture absorption layer formed thereon and at least a portion of a glass substrate having a first electrode, an organic layer, and a second electrode formed thereon. Then, the two substrates were combined, thereby completing the manufacture of an organic light emitting device.

### EXAMPLE 2

An organic light emitting device was manufactured in the same manner as in Example 1, except that 2 parts by weight of titanium black was used to form the transparent moisture absorption layer.

### EXAMPLE 3

An organic light emitting device was manufactured in the same manner as in Example 1, except that carbon black instead of titanium black was used to form transparent moisture absorption layer.

### EXAMPLE 4

An organic light emitting device was manufactured in the same manner as in Example 1, except that cobalt aluminate instead of titanium black was used to form the transparent moisture absorption layer.

### EXAMPLE 5

An organic light emitting device was manufactured in the same manner as in Example 1, except that silver colloid instead of titanium black was used to form the transparent moisture absorption layer.

### EXAMPLE 6

An organic light emitting device was manufactured in the same manner as in Example 1, except that gold-ruthenium colloid instead of titanium black was used to form the transparent moisture absorption layer.

### EXAMPLE 7

An organic light emitting device was manufactured in the same manner as in Example 1, except that back dye instead of titanium black was used to form the transparent moisture absorption layer.

All of the transparent moisture absorption layers formed in Examples 1 through 7 had a maximum moisture absorption ration of 30% with respect to their own weight and a transmittance of 95% or greater.

### COMPARATIVE EXAMPLE 1

An organic light emitting was manufactured in the same manner as in Example 1, except that no transparent moisture absorption layer was not formed on a top surface of the soda glass substrate.

### COMPARATIVE EXAMPLE 2

A conventional getter (HD-204, Dynic Inc., Tokyo, Japan) was formed on a soda glass substrate. An epoxy resin was applied as a sealant to at least a portion of the soda glass substrate and at least a portion of a glass substrate having a first electrode, an organic layer, and a second electrode formed thereon. Then, the two substrates were combined by pressing, thereby completing the manufacture of an organic light emitting device.

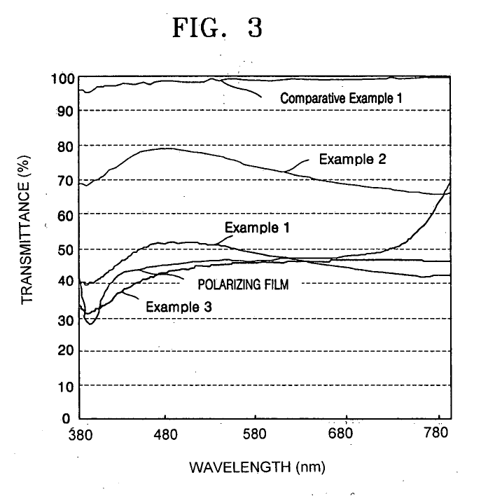

The transmittances of the transparent moisture absorption layers obtained in Examples 1-3 and Comparative Example 1 were measured. The results are shown in FIG. 3.

Referring to FIG. 3, the transmittances of the transparent moisture absorption layers in Examples 1 and 3 are almost the same as the transmittance of a polarizing film at about 50%. The transmittance of the transparent moisture absorption layer according to Example 2 in which the amount of the light absorbing material was reduced is about 75%. In other words, according to the present embodiments, the transmittance of the transparent moisture absorption layer can be varied in a range of 40-90% by varying the amount of the light absorbing material.

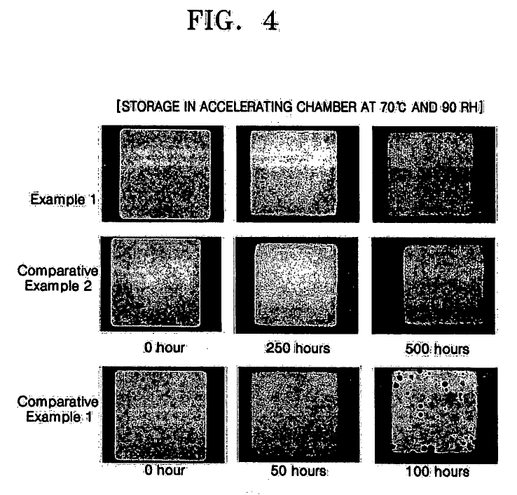

The organic light emitting devices obtained in Example 1 and Comparative Examples 1 and 2 were stored at 70° C. and 90% RH and their images were observed using a microscope over time. The results are shown in FIG. 4.

The organic electroluminescent devices obtained in Examples 1-5 and Comparative Examples 1 and 2 were stored at 70° C. and 90% RH, and changes in brightness with time were microscopically observed.

As a result, in the condition of 70° C. and 90% RH under which brightness reduction accelerates, which corresponds to 20,000-30,000 hours when converted into time, 90% of the initial brightness is maintained even after 500 hours. This initial brightness level is equal to or greater than when a conventional opaque desiccant is used (Comparative Example 2).

According to the present embodiments, a front emission type organic light emitting device with greater moisture absorption and longer lifetime than a light emitting device using a conventional getter can be manufactured using a transparent moisture absorption layer. The transparent moisture absorption layer according to the present embodiments has excellent moisture absorption and oxygen adsorption properties and extended lifetime. In addition, the transmittance of the transparent moisture absorption layer can be controlled in a range of about 40 to about 90% by adding a light absorbing material, such as a black pigment, a black dye, a metal nanocolloid, and the like., which have a particle size of about 30 nm or less, thereby lowering the reflection of external light and improving the contrast. In addition, the transparent moisture absorption layer having a transmittance of about 40 to about 60%, which can improve the contrast, and a transparent anti-reflective film can replace a conventional moisture absorption layer and a polarizing film having a transmittance of about 50% at lower cost. An etched glass substrate or a unetched flat glass, which are further processed, can be used as a front substrate. Thus, a structural weakness (fracture characteristic) arising when an etched glass substrate is used can be overcome.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. An organic light emitting device comprising:
a substrate;
an encapsulation substrate;
an organic light emitting unit interposed between the substrate and the encapsulation substrate; and
a transparent moisture absorption layer interposed between the substrate and the encapsulation substrate containing at least one of a metal oxide and a metal salt with an average particle diameter of about 100 nm or less, a binder, and a light absorbing material capable of absorbing light in a visible wavelength range.

2. The organic light emitting device of claim 1, wherein the light absorbing material is at least one selected from the group consisting of an inorganic pigment, an inorganic dye, and a metal nanocolloid.

3. The organic light emitting device of claim 2, wherein the inorganic pigment is at least one selected from the group consisting of an inorganic pigment, an inorganic dye, and a metal nanocolloid; the inorganic dye is at least one selected from the group consisting of black dye, Levanyl Black, Nigrosin Black, and Sudan Black; and the metal nanocolloid is at least one selected from the group consisting of silver nanocolloid, gold nanocolloid, gold-silver nanocolloid, and gold-ruthenium nanocolloid.

4. The organic light emitting device of claim 1, wherein the amount of the light absorbing material is in a range of about 0.1 to about 10 parts by weight based on 100 parts by weight of at least one of the metal oxide and the metal salt with an average particle diameter of about 100 nm or less.

5. The organic light emitting device of claim 1, wherein the light absorbing material has an average particle diameter of about 100 nm or less.

6. The organic light emitting device of claim 1, further comprising an anti-reflection layer on an external surface of the encapsulation substrate.

7. The organic light emitting device of claim 6, wherein the anti-reflection layer has a transmittance of about 95 to about 98%.

8. The organic light emitting device of claim 1, wherein the transparent moisture absorption layer is formed either on an inner surface of the encapsulation substrate, on a sidewall of a sealant layer which combines the substrate and the encapsulation substrate, or on a portion of at least one of the substrate and the encapsulation substrate.

9. The organic light emitting device of claim 1, wherein at least one of the metal oxide and the metal salt is selected from the group consisting of an alkali metal oxide, an alkali earth metal oxide, a metal halide, a metal sulfate, and a metal perclorate.

10. The organic light emitting device of claim 10, wherein the alkali metal oxide is selected from the group consisting of lithium oxide (Li₂O), sodium oxide (Na₂O), and potassium oxide (K₂O);
the alkali earth metal oxide is selected from the group consisting of barium oxide (BaO), calcium oxide (CaO), and magnesium oxide (MgO);
the metal sulfate is selected from the group consisting of lithium sulfate (Li₂SO₄), sodium sulfate (Na₂SO₄), calcium sulfate (CaSO₄), magnesium sulfate (MgSO₄), cobalt sulfate (CoSO₄), gallium sulfate (Ga₂(SO₄)₃), titanium sulfate (Ti(SO₄)₂), and nickel sulfate (NiSO₄);
the metal halide is selected from the group consisting of calcium chloride (CaCl₂), magnesium chloride (MgCl₂), strontium chloride (SrCl₂), yttrium chloride (YCl₂), copper chloride (CuCl₂), cesium fluoride (CsF), tantalum fluoride (TaF₅), niobium fluoride (NbF₅), lithium bromide (LiBr), calcium bromide (CaBr₃), cerium bromide (CeBr₄), selenium bromide (SeBr₂), vanadium bromide (VBr₂), magnesium bromide (MgBr₂), barium iodide (BaI₂), and magnesium iodide (MgI₂); and
the metal perchlorate is selected from the group consisting of barium perchlorate (Ba(ClO₄)₂) and magnesium perchlorate (Mg(ClO₄)₂).

11. The organic light emitting device of claim 1, wherein the metal oxide is anhydrous calcium oxide (CaO).

12. The organic light emitting device of claim 1, wherein the transparent moisture absorption layer further contains a dispersant in an amount between about 1 to about 100 parts by weight based on 100 parts by weight of at least one of the metal oxide and the metal salt.

13. The organic light emitting device of claim 12, wherein the dispersant includes at least one dispersant selected from the group consisting of a low molecular weight organic dispersant, a high molecular weight organic dispersant, a high molecular organic/inorganic complex dispersant, a low molecular organic/inorganic complex dispersant, and an organic acid in an amount between about 1 to about 100 parts by weight based on 100 parts by weight of the at least one of the metal oxide and the metal salt.

14. The organic light emitting device of claim 1, wherein the binder includes at least one selected from the group consisting of an organic binder, an inorganic binder, and an organic/inorganic complex binder, and
the amount of the binder is about 10 to about 5000 parts by weight, based on 100 parts by weight of the at least one of the metal oxide and the metal salt.

15. The organic light emitting device of claim 14, wherein the organic binder includes at least one resin selected from the group consisting of an acrylic resin, a methacrylic resin, polyisoprene, a vinyl resin, an epoxy resin, a urethane resin, and a cellulose resin;
the inorganic binder includes at least one material selected from the group consisting of titania, silicon oxides, zirconia, alumina, and a precursor thereof; and
the organic/inorganic complex binder includes at least one compound selected from the group consisting of epoxy silane or its derivatives, vinyl silane or its derivatives, amine silane or its derivatives, methacrylate silane or its derivatives, and a partially cured product thereof.

16. The organic light emitting device of claim 1, wherein the transparent moisture absorption layer has a thickness of about 0.1 to about 300 μm.

17. The organic light emitting device of claim 1, wherein the transparent moisture absorption layer has a transmittance of about 95 to about 98% and a moisture absorption ratio of about 30 to about 50%.

18. A method of manufacturing an organic light emitting device, comprising:
preparing a substrate with an organic light emitting unit including a first electrode, an organic layer, and a second electrode sequentially layered on the substrate;
coating at least one of an encapsulation substrate, a sealant layer, a groove portion of an etched glass substrate and an etched portion of an etched glass substrate with a composition for forming a transparent moisture absorption layer in an internal space between the substrate and the encapsulation substrate and curing the composition to obtain a transparent moisture absorption layer, the composition comprising at least one material selected from a metal oxide and a metal salt having an average particle diameter of about 100 nm or less, a binder, a light absorbing material absorbing light in a visible wavelength range, and a solvent;
coating a sealant on an outer region of the organic light emitting unit on at least one of the substrate and the encapsulation substrate; and
combining the substrate and the encapsulation substrate.

19. The method of claim 18, wherein the amount of the light absorbing material in the composition is in a range of about 0.1 to about 10 parts by weight based on 100 parts by weight of at least one of the metal oxide, and the amount of the binder in the composition is in a range of about 10 to about 5000 parts by weight based on 100 parts by weight of at least one of the metal oxide and the metal salt.

20. The method of claim 18, wherein the solvent used in the composition includes at least one selected from the group consisting of ethanol, methanol, propanol, butanol, isopropanol, methyl ethyl ketone, pure water, propylene glycol (mono)methyl ether (PGM), isopropyl cellulose (IPC), methyl (2-ethoxyethanol) (MC), and ethyl (2-ethoxyethanol) (EC), and
the amount of the solvent is in a range of about 100 to about 1900 parts by weight based on 100 parts by weight of the at least one of the metal oxide and the metal salt.

21. The method of claim 18, wherein the composition for forming the transparent moisture absorption layer further contains a dispersant in an amount of about 1 to about 100 parts by weight based on 100 parts by weight of at least one of the metal oxide and the metal salt.

22. The method of claim 18, wherein the coating of the composition is performed using dip coating, spray coating, dispensing, or screen printing.

23. The method of claim 18, wherein the curing of the composition is performed using thermal curing or UV curing.

24. The method of claim 23, wherein the thermal curing is performed at a temperature of about 100 to about 250° C.
